(19) United States
(12) Patent Application Publication
(10) Pub. No.: US 2026/0269680 A1
(43) Pub. Date: Sep. 10, 2026

(54) HYBRID MODULE

(71) Applicant: Schaeffler Technologies AG & Co. KG, Herzogenaurach (DE)

(72) Inventors: Aurelie Keller, Herrlisheim (FR); Ivo Agner, Bühl (DE); Steffen Lehmann, Ettlingen (DE); Alexander Voit, Sinzheim (DE); Andreas Trinkenschuh, Bühl (DE)

(73) Assignee: Schaeffler Technologies AG & Co. KG, Herzogenaurach (DE)

(21) Appl. No.: 19/489,186

(22) PCT Filed: May 15, 2024
(86) PCT No.: PCT/DE2024/100452

§ 371 Date: Dec. 1, 2025

(30) Foreign Application Priority Data
Jun. 1, 2023 (DE) 10 2023 114 388.3

(51) Int. Cl. H02K 5/24; H02K 5/173; H02K 7/00; H02K 7/08; H02K 11/21

(52) U.S. Cl. CPC H02K 5/24; H02K 5/1732; H02K 7/006; H02K 7/083; H02K 11/21

(57) ABSTRACT

A hybrid module for a drive train of a motor vehicle includes an electric machine with a stator and a rotatable rotor mounted coaxially relative to the stator, and a vibration damper arranged coaxially to the rotor and having a damper input part and a damper output part as well as at least one energy store arranged in the torque flow between the damper input part and the damper output part. The damper output part is coupled to the rotor and the damper input part is coupled to an internal combustion engine. The electric machine and the vibration damper are accommodated in a hybrid module housing. The rotor is torque-transmittingly connected to a rotor hub and a sensor target of a rotor position sensor is coupled to the rotor hub in a rotationally fixed manner.

### CROSS REFERENCE TO RELATED APPLICATIONS

This application is the United States National Phase of PCT AppIn. No. PCT/DE 2024/100452, filed May 15, 2024, which claims priority to German Application No. DE 10 2023 114 388.3, filed Jun. 1, 2023, the entire disclosures of which are incorporated by reference herein.

### FIELD OF INVENTION

The present invention relates to a hybrid module for a drive train of a motor vehicle, including an electric machine having a stator and a rotor which is rotatable and mounted coaxially relative to the stator, and a vibration damper arranged coaxially with respect to the rotor and having a damper input part and a damper output part, as well as at least one energy store arranged in the torque flow between the damper input part and the damper output part, the damper output part being coupled to the rotor and the damper input part being couplable to an internal combustion engine, and the electric machine and the vibration damper being accommodated in a hybrid module housing.

### BACKGROUND

A drive train of a hybrid vehicle includes a combination of an internal combustion engine and an electric motor and enables—for example, in urban areas—a purely electric mode of operation with sufficient range and availability, in particular when driving cross-country. In addition, drive is possible simultaneously with the internal combustion engine and the electric motor in certain operating situations.

As is known from EP0773127A1, DE10018926A1 and US2007/0175726A1, a first clutch arrangement may be arranged between the internal combustion engine and the electric motor to separate the internal combustion engine from the electric motor and the rest of the drive train of the hybrid vehicle. In the case of a purely electric drive, the first clutch arrangement is then opened and the internal combustion engine switched off, so that the output torque of the hybrid vehicle is generated solely by the electric motor.

In order to optimize the smooth running of hybrid drive trains in motor vehicles, torsional vibration dampers are often used in the drive train.

Torsional vibration dampers are generally known for damping torsional vibrations of a drive shaft of a motor vehicle engine. For example, a dual-mass flywheel is known from DE 10 2008 004 70 A1, in which a primary flywheel is coupled via an arc spring to a secondary flywheel that may be rotated relative to the primary flywheel in order to dampen torsional vibrations of a crankshaft of an internal combustion engine. The arc spring is arranged in an arc spring channel, a channel wall of the arc spring channel being formed by the primary flywheel. A flange of the secondary flywheel protrudes into the arc spring channel and is supported against the channel wall by a friction ring.

A further torsional vibration damper is known, for example, from the document WO14094761A1. The torsional vibration damper disclosed therein includes an input part and an output part which may be rotated to a limited extent counter to the action of a spring device formed by arc springs distributed over the circumference and which has a retaining shell for the arc springs under centrifugal force. The output-side loading means of the output part are formed by carrier elements projecting from the output part.

There remains a continuing need to design such hybrid modules with a particularly compact axial design, since in hybrid drive trains the electric machine must be integrated into existing systems and architectures, and therefore the requirements for a compact installation space are usually very pronounced.

### SUMMARY

Therefore, an object of the present disclosure is to address this need and to avoid or at least mitigate existing disadvantages and to provide a hybrid module with a particularly compact axial design.

This object is addressed by a hybrid module for a drive train of a motor vehicle, including an electric machine having a stator and a rotor which is rotatable and mounted coaxially relative to the stator, and a vibration damper arranged coaxially with respect to the rotor and having a damper input part and a damper output part, as well as at least one energy store arranged in the torque flow between the damper input part and the damper output part, the damper output part being coupled to the rotor and the damper input part being couplable to an internal combustion engine, and the electric machine and the vibration damper being accommodated in a hybrid module housing, the rotor being torque-transmittingly connected to a rotor hub and a sensor target of a rotor position sensor being coupled to the rotor hub in a rotationally fixed manner.

This provides the advantage that a particularly compact axial hybrid module with a rotor position sensor may be provided.

In the context of this application, the drive train of a motor vehicle is understood to mean all components which, in the motor vehicle, generate the power for driving the motor vehicle and transmit it to the road via the vehicle wheels. For the purposes of the present application, motor vehicles are land vehicles that are moved by machine power without being bound to railroad tracks. A motor vehicle may be selected, for example, from the group of passenger cars, trucks, small motorcycles, light motor vehicles, motorcycles, motor buses/coaches or tractors.

A hybrid electric vehicle (HEV) is an electric vehicle that is driven by at least one electric motor and another energy converter and draws energy from its electrical storage unit (battery) as well as from an additional fuel that it carries.

The torsional vibration damper may be a wet torsional vibration damper that is operated within a wet chamber. In principle, it is also conceivable to operate the torsional vibration damper in a dry chamber within the hybrid module.

A torsional vibration damper may, in particular, have the task of damping vibrations between a motor, such as an internal combustion engine or an electric machine, and, for example, a transmission within a drive train. Internal combustion engines in particular do not output a constant torque. The constantly changing angular speeds of the crankshaft generate vibrations that may be transmitted to the vehicle transmission via the coupling system and the transmission input shaft. In this case, these vibrations may cause undesired rattling noises. Torsional vibration dampers are designed to reduce these vibrations between the motor and the transmission.

The torsional vibration damper may be designed in particular as a dual-mass flywheel.

A torsional vibration damper may in particular include a primary flywheel designed as a damper input part, a secondary flywheel designed as a damper output part, a rotary plain bearing, one or more spring devices and optionally one or more damper devices. In the dual-mass flywheel (DMF), the flywheel mass is divided into the primary flywheel mass (primary flywheel) and the secondary flywheel mass (secondary flywheel). A spring device is arranged in the torque flow between the primary flywheel and the secondary flywheel and connects the primary flywheel and the secondary flywheel to each other in a torsionally compliant manner.

According to a further embodiment of the present disclosure, it is possible for the energy store of the vibration damper to include a spring device. The spring device may in particular also include at least one arc spring and/or at least one compression spring. The spring device may also be formed from a plurality of spring devices acting in parallel and/or in series.

In order to dampen the torsion between the damper input part and the damper output part, a damping device, for example in the form of a friction clutch, may be arranged in the torque flow between the damper input part and the damper output part.

The damper input part has the function of coupling the drive side of the torsional vibration damper with the energy store. The damper input part may in particular be designed in several parts and include a primary flywheel disc, which may in particular be connected to a primary wheel hub via a primary connecting disc. The primary flywheel disc and the primary connecting disc may be connected to each other in a rotationally fixed manner via rivet connections. The damper input part may be made of a metallic material.

The damper output part has the function of coupling the output side of the torsional vibration damper with the energy store. The damper output part may in particular be designed in several parts and include a secondary flywheel disc, which may in particular be connected to a secondary wheel hub via a secondary connecting disc. The secondary flywheel disc and the secondary connecting disc may be connected to each other in a rotationally fixed manner via rivet connections. The damper output part may be made of a metallic material.

The damper input part may in particular have a receptacle for the energy store, in particular the spring device. The receptacle, in particular for an arc spring, may be arranged in a channel-like manner in the damper input part. It is particularly contemplated that the receptacle for the spring device is formed monolithically with the damper input part. Such a receptacle is also called a retainer or spring retainer.

It is particularly contemplated to use the torsional vibration damper in a hybrid module.

In a hybrid module, structural and functional elements of a hybridized drive train may be spatially and/or structurally combined and preconfigured such that a hybrid module may be integrated into a drive train of a motor vehicle in a particularly simple manner. In particular, an electric motor and a torsional vibration damper may be present in a hybrid module. Furthermore, it is possible that, additionally or alternatively to the torsional vibration damper, a coupling system, in particular having a separating clutch for engaging the electric motor in and/or disengaging the electric motor from the drive train, may be present in a hybrid module.

A hybrid module according to the present disclosure may be divided into the following categories PO-P4 depending on the point of engagement of the electric motor in the drive train:

PO: The electric motor is arranged upstream of the internal combustion engine and is coupled to the internal combustion engine by means of a belt, for example. With this arrangement of the electric motor, it is also sometimes referred to as a belt-driven starter generator (BSG).

P1: The electric motor is arranged directly behind the internal combustion engine. The electric motor may be arranged, for example, fixed to the crankshaft in front of the starting clutch.

P2: The electric motor is arranged between a separating clutch, often referred to as KO, and the starting clutch but before the vehicle transmission in the drive train,

P3: The electric motor is arranged in the vehicle transmission and/or transmission output shaft.

P4: The electric motor is arranged on an existing or separate vehicle axle.

P5: The electric motor is arranged on or in the vehicle wheel, for example as a wheel hub motor.

In connection with the present disclosure, it is particularly contemplated that the hybrid module is configured as a P1 hybrid module.

For the purposes of the present application, motor vehicles are land vehicles that are moved by machine power without being bound to railroad tracks. A motor vehicle may be selected, for example, from the group of passenger cars, trucks, small motorcycles, light motor vehicles, motorcycles, motor buses/coaches or tractors.

In particular, the electric machine of the hybrid module is dimensioned such that vehicle speeds of more than 50 km/h, such as more than 80 km/h, and in particular more than 100 km/h may be achieved. The electric motor particularly has an output of more than 30 KW, such as more than 50 KW, and in particular more than 70 KW. Furthermore, it is contemplated that the electric machine provides rotational speeds greater than 5000 rpm, particularly greater than 10,000 rpm, and very particularly greater than 12,500 rpm.

The power electronics unit for supplying current to the electric machine may be accommodated in an inverter housing. The inverter housing may be formed from a metallic material, particularly from aluminum, gray cast iron or cast steel, in particular by means of a primary shaping process such as casting or die-casting. The inverter housing particularly has a pot-like three-dimensional shape. In this context, it is particularly contemplated that the housing cover may be inserted into the pot-like inverter housing. Alternatively, it would also be conceivable for the housing cover to rest on the pot-like inverter housing and cover its opening.

The inverter housing may also be part of the motor housing or vice versa. This means that the inverter housing is formed completely or partially integrally, in particular monolithically, with the motor housing.

The power electronics unit accommodated in the inverter housing may be provided in particular for an electric machine of a hybrid module. The power electronics unit may be a combination of different components that control or regulate a current to the electric machine of the hybrid module, including the peripheral components required for this purpose, such as cooling elements or power supply units. In particular, the power electronics unit contains one or more power electronics unit components that are configured to control or regulate a current. These may be one or more power switches, such as power transistors. The power electronics unit may particularly have more than two, and particularly three, phases or current paths which are separate from one another and which each have at least one separate power electronics unit component. The power electronics unit may be designed for controlling or regulating a power per phase with a peak power, such as a continuous power, of at least 10 W, such as at least 100 W, and particularly at least 1000 W.

The power electronics unit may also have a control electronics unit and/or a sensor electronics unit for the hybrid module, for example an ACU. The power electronics unit module may have at least one motor current connection and/or one electric signal connection.

The function of the cooling fluid in the rotor and/or stator is to dissipate heat as efficiently as possible from regions of the stator and/or rotor that are heating up and to prevent these regions from undesirably overheating. In addition to this main task, the cooling fluid may in particular also provide lubrication and corrosion protection for the moving parts and/or the metal surfaces of the cooling system of the stator or the electric machine. In addition, it may, in particular, also remove contaminants (for example as caused by abrasion), water and air. The cooling fluid may be a liquid. The cooling fluid may, in particular, be an oil. In principle, however, it is also conceivable to use aqueous cooling fluids, for example also emulsions, such as water-glycol mixtures.

The cooling fluid of the stator and/or the rotor may be connected to a hydraulic cooling system with a hydraulic cooling circuit. Such a hydraulic cooling system is used to dissipate the heat generated by electrical losses within an electric machine. Such a cooling system may have cooling channels within the rotor (rotor cooling channel) and/or stator (stator cooling channel), in particular also a flow through the stator slots, through which a corresponding cooling fluid is guided for the purpose of removing the heat.

The cooling fluid may particularly be conveyed through the hydraulic circuit by means of a pump. In principle, it is conceivable to design a plurality of hydraulic circuits in order to cool the electric machine. In this case, it is contemplated that the cooling channels of the stator are connected to a hydraulic cooling circuit or to various cooling circuits of the cooling system. In particular, by connecting to a plurality of cooling circuits, it is possible to provide more precise cooling, since, for example, the temperature of the cooling fluid when entering the cooling channels of the stator, the flow velocity of the cooling fluid or even the type of cooling fluid (oil, emulsion) may be adjusted.

The electric machine may be configured as an axial flux machine or radial flux machine. A radial flux machine is characterized by the fact that the magnetic field lines in the air gap formed between the rotor and stator extend in a radial direction. The gap between the rotor and the stator is referred to as the air gap. In a radial flux machine, this is a gap with a circular ring-shaped cross-section with a radial width that corresponds to the distance between the rotor body and the stator body. On the other hand, the magnetic flux in an electric axial flux machine (AFM) is directed axially to a direction of rotation of the rotor of the axial flux machine in the air gap between the stator and the rotor.

The radial flux machine may be designed as an internal rotor or an external rotor. In connection with the present disclosure, the design as an internal rotor is contemplated.

A rotor of a radial flux machine includes in particular a rotor shaft. The rotor shaft may be hollow, which on the one hand results in weight savings and on the other hand allows the supply of lubricant or coolant to the rotor body.

A rotor body for the purposes of the present disclosure is therefore understood to mean the rotor without a rotor shaft. The rotor body is therefore made in particular of a rotor lamination stack and the permanent magnets inserted into the pockets of the rotor lamination stack or fixed to the circumference of the rotor lamination stack as well as any axial cover parts for closing the pockets.

The rotor may have a plurality of rotor bodies. Particularly, the rotor bodies are formed substantially of the same parts, in particular substantially identically. It is contemplated that the rotor body is formed from identical, in particular substantially identical rotor laminations. The rotor body may be formed from a rotor lamination stack, which is composed of a plurality of laminated individual laminations or rotor laminations, usually made of electrical steel, which are layered and stacked one above the other to form a stack, what is referred to as the rotor lamination stack. The individual laminations may be joined together in the rotor lamination stack by adhesive bonding, welding or screwing. A rotor lamination stack may in particular also have permanent magnets which are inserted into the pockets of the rotor lamination stack or which are fixed circumferentially to the rotor lamination stack. It is possible that the rotor lamination stacks are offset with respect to each other, i.e., they are arranged at an angle to each other. This offset may be linear or V-shaped to avoid or at least reduce axial forces.

The permanent magnets to be introduced into the pockets of the rotor lamination stack are understood as the rotor magnet. The permanent magnets may be inserted into the pockets of the rotor lamination stack. A single larger rotor magnet designed as a bar magnet or a plurality of smaller rotor magnets designed as permanent magnet elements may be provided for each pocket.

A rotor lamination stack may in particular form a rotor body. A rotor lamination stack is understood to mean a plurality of laminated individual laminations or rotor laminations, which are generally made from electrical steel and are stacked and packaged one on top of the other to form a stack, or what is referred to as a “rotor lamination stack.” The individual laminations may then be joined together in the laminated core by adhesive bonding, welding, or screwing. In particular, a rotor lamination stack may also have magnet elements inserted into the pockets of the rotor lamination stack or fixed to the circumference of the rotor lamination stack as well as any axial cover parts for closing the pockets and the like.

A stator of a radial flux machine may be designed as a hollow cylinder, with the rotor then extending axially through the stator in an internal rotor configuration.

A winding with conductors may particularly be embedded in the stator slots of the stator. A conductor is in particular an electrically conductive conductor with two conductor portions which run in parallel and include longitudinal extensions that are significantly larger than their diameters. In principle, the conductor portions may have any cross-sectional shape other than a circular shape. Rectangular cross-sectional shapes are contemplated since these allow for high packing densities and consequently high power densities to be achieved.

Particularly, a conductor is formed of copper. A conductor may be insulated. To insulate the conductors, for example, mica paper, which for mechanical reasons may be reinforced by a glass fabric carrier, may be wound in tape form around one or more stator windings, which are impregnated by means of a curing resin. In principle, it is also possible to use a curable lacquer layer without mica paper to insulate a conductor.

The winding may be designed as a hairpin winding or wave winding. In this context, it is further contemplated that the conductors are designed as hairpin conductors.

The stator according to the present disclosure may also have at least one stator body. The stator body may be made in one piece or in several parts, in particular in a segmented manner. A one-piece stator body is characterized by the fact that the entire stator body is formed in one piece as viewed over the circumference. The stator body is usually formed from a plurality of stacked laminated electrical steel sheets, wherein each of the electrical steel sheets is closed to form an annular ring. A segmented stator body is characterized by the fact that it is constructed from individual stator segment parts. The stator body may be constructed from individual stator teeth or stator tooth groups, and each individual stator tooth or each individual stator tooth group may be formed from a plurality of stacked laminated electrical steel sheets, with each of the electrical steel sheets being designed as a stator segment lamination part.

The stator body may be formed from one or more stator laminated cores. A stator laminated core is understood to mean a plurality of laminated individual laminations or stator sheets, which are generally made from electrical steel and are layered and packed one on top of the other to form a stack or what is referred to as a stator laminated core. The individual laminations may then remain held together in the laminated core, for example, by adhesive bonding, welding or screwing.

The stator teeth of the stator may be formed in the stator body. Stator teeth are components of the stator body which are designed as circumferentially spaced, tooth-like parts of the stator body that are directed radially inward, with an air gap for the magnetic field being formed between the free ends of the stator teeth and a rotor body. The gap between the rotor and the stator is referred to as the air gap. In a radial flux machine, this is a substantially circular ring-shaped gap with a radial width that corresponds to the distance between the rotor body and the stator body.

According to an advantageous embodiment of the present disclosure, the plurality, such as all, of the electric conductors have a substantially rectangular contour in cross-section. The advantage of this embodiment is that electric conductors that are generally available as standard may be used to form the stator winding, which is particularly favorable in terms of the manufacturing costs of the stator.

The stator slots may be closed by a slot-closure means so that the cooling fluid cannot flow from the stator slots into the air gap between the rotor and the stator. Particularly, the slot-closure means may be a slot-closure wedge.

The hydraulic cooling system also particularly may have winding head cooling, by means of which the cooling fluid may be applied to at least one winding head, at least in portions.

The stator may be accommodated in a motor housing which surrounds the stator or the electric machine. A motor housing may also accommodate the control and power electronics unit. The motor housing may furthermore be part of a cooling system for the electric machine, and may be designed such that cooling fluid may be supplied to the electric machine via the motor housing and/or the heat may be dissipated to the outside via the housing surfaces. In addition, the motor housing protects the electric machine and any electronics that may be present from external influences.

A motor housing may be formed in particular from a metallic material. Advantageously, the motor housing may be formed from a metallic cast material, such as die-cast aluminum, die-cast magnesium, gray cast iron, or cast steel.

Depending on the application, it may be advantageous to design an axial flux machine in an I-arrangement or an H-arrangement. In an I-arrangement, the rotor is arranged to be axially adjacent to a stator or between two stators. In an H-arrangement, two rotors are arranged on opposite axial sides of a stator.

In principle, it is also possible for a plurality of rotor-stator configurations to be arranged axially adjacent as an I-type and/or H-type. In this context, it would also be possible to arrange a plurality of I-type rotor-stator configurations adjacent to each other in an axial direction. In particular, it is also contemplated that the rotor-stator configurations of the H-type and/or the I-type are each designed substantially identically, so that they may be joined together in a modular manner to form an overall configuration. Such rotor-stator configurations may in particular be arranged to be coaxial to one another and may be connected to a common rotor shaft or to a plurality of rotor shafts.

The stator of an electric axial flux machine may include a stator body having a plurality of stator windings arranged in a circumferential direction. The stator body may be designed to be in one piece or segmented, as viewed in a circumferential direction. The stator body may be formed from a stator laminated core with a plurality of laminated electrical steel sheets. Alternatively, the stator body may also be formed from a compressed soft magnetic material, such as what is referred to an SMC (soft magnetic compound) material.

The stator is advantageously accommodated in a housing. The housing may be formed in one piece or in several parts. The housing may be made of a plastic. The housing may be designed to be closed on all sides. It is also possible to provide openings in the housing, for example to reduce weight or to provide access to a component.

The magnet elements may be designed as permanent magnets, for example. The magnet elements may be designed to be substantially identical.

A rotor shaft is a rotatably mounted shaft of an electric machine to which the rotor or rotor body is coupled in a rotationally fixed manner.

The electric axial flux machine may furthermore have a control device. A control device, as used in the present disclosure, serves in particular for the electronic control and/or regulation of one or more technical systems of the electric axial flux machine.

The hybrid module may be coupled on the output side to a transmission arranged within the drive train of the motor vehicle. The transmission may be designed as a manual or automatic transmission. In particular, the transmission also has a transmission input shaft which may be inserted axially into the hybrid module.

According to a further embodiment of the present disclosure, a hybrid module for a drive train of a motor vehicle may be provided, including an electric machine having a stator and a rotor which is rotatable and mounted coaxially relative to the stator, and a vibration damper arranged coaxially with respect to the rotor and having a damper input part and a damper output part, as well as at least one energy store arranged in the torque flow between the damper input part and the damper output part, the damper output part being coupled to the rotor and the damper input part being couplable to an internal combustion engine, and the electric machine and the vibration damper being accommodated in a hybrid module housing, the rotor being torque-transmittingly connected to a rotor hub, the rotor hub including a first connection portion having an internal spline for torque-transmitting coupling with a shaft and a second connection portion having an external spline, the external spline engaging with a corresponding internal spline of the damper output part.

This results in an axially compact and easy-to-assemble design of a hybrid module.

According to an advantageous embodiment of the present disclosure, it is possible for a first rolling bearing to be arranged at the end of the rotor hub facing towards the internal combustion engine, wherein, in the state of the hybrid module installed with the internal combustion engine, the rotor hub engages axially in a crankshaft and may be rotatably mounted relative to the crankshaft via the first rolling bearing.

According to a further development of the present disclosure, it is also possible for a second rolling bearing to be arranged in an axial direction between the external spline and the internal spline of the rotor hub on the inner lateral surface thereof, which second rolling bearing rotatably supports the rotor hub relative to the shaft.

Furthermore, according to a likewise advantageous embodiment of the present disclosure, it is possible for a third rolling bearing to be arranged in an axial direction between the external spline and the internal spline of the rotor hub on the outer lateral surface thereof, which third rolling bearing rotatably supports the rotor hub relative to the stator.

Particularly, the third rolling bearing may be provided in conjunction with the first or second rolling bearing for supporting the rotor hub.

According to a further embodiment of the present disclosure, it is possible for the external spline to have a diameter which is smaller than the diameter of the outer lateral surface of the rotor hub, whereby the mountability, in particular the axial insertability of the rotor hub during its assembly may be improved.

Furthermore, the present disclosure may also be further developed in such a way that the internal spline has a diameter that is larger than the diameter of the inner lateral surface of the rotor hub, whereby the mountability, in particular the axial insertability of the rotor hub during its assembly may also be improved.

In a likewise embodiment variant of the present disclosure, it is also possible for the electric machine to be designed as an axial flux machine, whereby a hybrid module with a particularly compact axial design may be realized.

It may also be advantageous to further develop the present disclosure such that the shaft is a transmission input shaft.

According to a further embodiment of the subject matter of the present disclosure, it is possible for the first rolling bearing and/or the second rolling bearing to be designed as needle bearings, which allows comparatively high radial loads with a compact radial structure.

Finally, the present disclosure may also be advantageously designed such that the third rolling bearing is configured as a double-row deep groove ball bearing, whereby the third rolling bearing may absorb tilting moments of the rotor hub occurring in particular during operation of the rotor.

According to a further embodiment of the present disclosure, a hybrid module for a drive train of a motor vehicle may be realized, including an electric machine having a stator and a rotor which is rotatable and mounted coaxially relative to the stator, and a vibration damper arranged coaxially with respect to the rotor and having a damper input part and a damper output part, as well as at least one energy store arranged in the torque flow between the damper input part and the damper output part, the damper output part being coupled to the rotor and the damper input part being couplable to an internal combustion engine, and the electric machine and the vibration damper being accommodated in a hybrid module housing, the vibration damper having an outer diameter smaller than the stator diameter of the stator, such that an installation space within the hybrid module housing is defined radially outside the vibration damper and/or radially outside the stator, through which installation space at least one electrical connection means of the electric machine and/or at least one cooling connection means of the electric machine passes at least partially.

This provides the advantage that in a hybrid module with a torsional vibration damper connected in series in the power flow and an electric machine, the torsional vibration damper is designed in such a way that the radially outer installation space may be used for the connection of the electrical and cooling connections. This allows, for example, both the active parts of the electric machine to be cooled or energized, and the radial installation space in the hybrid module housing to be optimally utilized, which also enables more torque and power in a shorter axial installation space due to the larger effective diameter.

According to an advantageous embodiment of the present disclosure, it is possible for the outer diameter of the vibration damper to be smaller than 0.8 times the stator of the electric machine. The advantage of this embodiment is that there is sufficient space radially above the torsional vibration damper for electrical and/or hydraulic contacting of the electric machine.

According to a further development of the present disclosure, it is also possible for the electric machine to be connectable to a cooling circuit which may be coupled to the electric machine via the at least one cooling connection means, which may promote efficient and safe operation of the electric machine.

According to a further embodiment of the present disclosure, it is possible for the vibration damper and the stator of the electric machine to be arranged radially nested, which favors a hybrid module with a particularly compact axial design.

Furthermore, the present disclosure may also be further developed in such a way that an inverter for supplying current to the electric machine is arranged at least in partially in the installation space and is connected to the at least one electrical connection means, whereby a particularly compact hybrid module may also be realized.

In a likewise embodiment of the present disclosure, it is possible for the hybrid module housing to be designed in several parts. In this context, it may also be advantageous to further develop the present disclosure in such a way that the hybrid module housing is formed at a first end face at least partially by a housing of the internal combustion engine and/or at a second end face at least partially by a housing of a transmission. This enables a particularly high degree of system integration of the hybrid module into an existing drive train, which also promotes an axially compact design of the hybrid module.

Finally, the present disclosure may also be advantageously implemented in such a way that the hybrid module is configured as a P1 hybrid module in which the damper input part may be coupled to a crankshaft of an internal combustion engine.

It may also be advantageous to design a hybrid module for a drive train of a motor vehicle in such a way that it includes an electric machine having a stator and a rotor which is rotatable and mounted coaxially relative to the stator, and a vibration damper arranged coaxially with respect to the rotor and having a damper input part and a damper output part, as well as at least one energy store arranged in the torque flow between the damper input part and the damper output part, the damper output part being coupled to the rotor and the damper input part being couplable to an internal combustion engine, and the electric machine and the vibration damper being accommodated in a hybrid module housing, the electric machine being configured as an axial flux machine and the disc-like rotor having a plurality of magnet units distributed over the rotor in the circumferential direction, each of the magnet units having a first magnet element, a second magnet element and at least a third magnet element, the first magnet element and the second magnet element having a first contact surface extending in a radial direction, and the second magnet element and the third magnet element having a second contact surface extending in a radial direction, the magnet elements being magnetized in such a way that they form a Halbach array.

This has the advantage that the Halbach array of the magnet elements allows the required return path behind the magnet elements to be reduced or even eliminated completely. The magnet elements then take over, at least partially, such as completely, the deflection of the magnetic flux in the rotor. This allows the axial length of the rotor to be significantly reduced while at the same time increasing the maximum torque that may be generated. This makes it possible to provide an axial flux machine with a particularly compact design and a high power density in a hybrid module. The Halbach array of the magnet elements may also have a beneficial effect on the efficiency of the axial flux machine.

According to an advantageous embodiment of the present disclosure, the magnet units are substantially formed to be geometrically identical. This may realize manufacturing and cost advantages, which are due to the greater degree of uniformity of a corresponding rotor.

According to a further development of the present disclosure, it is also possible for the magnet units to be arranged distributed equidistantly around the circumference of the rotor. This ensures that the rotor has good concentricity and balancing properties.

Furthermore, according to a likewise advantageous embodiment of the present disclosure, it is possible for the structure fixing the magnet units in the rotor to be formed from plastic, whereby the rotor is particularly lightweight and may be produced cost-effectively. Furthermore, in this context, it is contemplated that the magnet units are arranged spaced apart from one another in a circumferential direction in the rotor.

According to a further embodiment of the present disclosure, it is possible for the electric machine includes exactly one stator and one rotor. This makes it possible to create a particularly compact axial flux machine and a correspondingly compact hybrid module.

Furthermore, the present disclosure may also be further developed in such a way that the magnet units are at least partially covered axially on both sides by an annular disc-like cover disc, which may contribute to fixing the magnet units axially in the rotor. The magnet units are located on the inside of the cover discs.

In a likewise embodiment of the present disclosure, it is also possible for the cover discs to be made of a plastic or an aluminum, which is advantageous both in terms of weight and cost.

It may also be advantageous to further develop the present disclosure in such a way that the rotor is fixed to a flange of a rotor hub in a torque-transmitting manner by means of rivet connections extending in an axial direction, which may also contribute to a hybrid module that is particularly compact axially, since the axial installation space requirement of a rivet connection is comparatively small compared to a screw connection, for example.

According to a further embodiment of the subject matter of the present disclosure, it is possible for the rivet connections to pass through both cover discs. This ensures that the axial forces applied by the rivet connection may be dissipated well and over a large area via the cover discs.

Finally, the present disclosure may also be advantageously designed such that the rotor does not have a magnetic return path element, in particular no iron yoke, whereby the rotor may be designed to be particularly lightweight and axially compact.

In a further embodiment variant of the present disclosure, a hybrid module for a drive train of a motor vehicle may be provided, including an electric machine having a stator and a rotor which is rotatable and mounted coaxially relative to the stator, and a vibration damper arranged coaxially with respect to the rotor and having a damper input part and a damper output part, as well as at least one energy store arranged in the torque flow between the damper input part and the damper output part, the damper output part being coupled to the rotor and the damper input part being couplable to an internal combustion engine, and the electric machine and the vibration damper being accommodated in a hybrid module housing, the electric machine being designed as an axial flux machine, the disc-like rotor of which is connected torque-transmittingly to a rotor hub, which includes on its outer lateral surface a rolling bearing, which rotatably supports the rotor hub against the stator, the air gap between the stator and the rotor hub being adjusted using a shim washer arranged on the rotor hub.

This has the advantage of enabling easy installation and very precise adjustment of the air gap.

According to an advantageous embodiment of the present disclosure, it is possible for the shim washer to rest axially, on the one hand, on the inner ring of the rolling bearing and, on the other hand, on a shoulder of the rotor hub, which brings advantages both in terms of manufacturing and assembly.

According to a further development of the present disclosure, it is also possible for the rolling bearing to be configured as a double-row deep groove ball bearing in an O-arrangement. This allows for particularly effective absorption of axial forces that develop between the stator and the rotor.

Furthermore, according to a likewise advantageous embodiment of the present disclosure, it is possible for the shim washer to bear axially against a flange of the rotor hub, on the one hand, and against the rotor, on the other hand.

In principle, it would also be possible for a first shim washer to rest axially on the inner ring of the rolling bearing, on the one hand, and on a shoulder of the rotor hub, on the other hand, and for a further shim washer to rest axially on a flange of the rotor hub, on the one hand, and on the rotor, on the other hand.

According to a further embodiment of the present disclosure, it is possible for the rotor to be fixed to a flange of a rotor hub in a torque-transmitting manner by means of rivet connections extending in an axial direction, which contributes to an axially particularly compact design of the hybrid module.

Furthermore, the present disclosure may also be further developed in such a way that the rolling bearing is arranged radially inside the stator, which also supports an axially compact design.

In a likewise embodiment variant of the present disclosure, it is also possible for the rolling bearing to be connected to the stator in a radial direction by means of an annular stator carrier connecting the rolling bearing and the stator.

According to an advantageous embodiment of the present disclosure, it is possible for the sensor target to extend in a radial direction out of the rotor hub, which may also contribute to a particularly compact axial structure of the hybrid module.

According to a further development of the present disclosure, it is also possible for the sensor target to be formed integrally, in particular monolithically, with the rotor hub. This enables a high degree of system integration to be achieved and, at the same time, advantages in terms of manufacturing and assembly technology may be realized.

In principle, however, it is also conceivable that the sensor target is designed as a component separate from the rotor hub.

To avoid structure-borne noise influences during operation of the electric machine, the stator may be mounted in an axial direction relative to the hybrid module housing by means of an annular stator carrier and the stator has no radial contact with the hybrid module housing. This may also improve the accuracy of rotor position determination.

Furthermore, according to a likewise advantageous embodiment of the present disclosure, it is possible for the sensor target to be designed as a toothed ring, which has proven to be particularly advantageous with regard to the most accurate and robust rotor position determination possible. The toothed ring may be formed either over a full circle or just over an annular portion. The toothed ring has a gear-like structure with a series of teeth or protrusions evenly spaced around the circumference of the sensor target. The rotor position sensor is used to determine the exact position of the rotor relative to the stator of the electric machine. The sensor detects the movement of the rotor by detecting the passing of the teeth or elevations of the toothed ring. Each tooth or protrusion then represents a specific position of the rotor.

According to a further embodiment of the present disclosure, it is possible for the sensor target and/or the rotor position sensor to be arranged in a space radially inside the stator, whereby the axial compactness of the hybrid module may be further optimized.

Furthermore, the present disclosure may also be further developed in such a way that the electric machine is designed as an axial flux machine, which is particularly favorable with regard to the most compact possible axial structure of the hybrid module.

In a likewise embodiment variant of the present disclosure, it is also possible for the rotor position sensor to be arranged on a rotationally fixed stator hub, which, via the interposition of a rolling bearing, connects the rotatable rotor hub to a stator carrier of the stator. This structural embodiment may also contribute to a particularly compact axial structure.

It may also be advantageous to further develop the present disclosure in such a way that the stator hub has a cable channel which runs axially through the stator hub and through which at least one electrical line passes for electrical contact with the rotor position sensor. This allows the electrical line to be guided radially outwards on a side of the stator facing away from the rotor.

According to a further embodiment of the subject matter of the present disclosure, it is possible for the stator carrier to have at least one cable guide, in particular a cable slot, extending in a radial direction, in which the electrical line is guided at least partially for electrical contact with the rotor position sensor, which may also contribute to a particularly compact embodiment of the hybrid module.

Finally, the present disclosure may also be advantageously implemented in such a way that the electric machine is configured as a radial flux machine, wherein a carrier component, arranged in a rotationally fixed manner with the stator and extending inwardly in a radial direction, carries the rotor position sensor, so that the rotor position sensor may also be integrated in a radial flux machine in an axially compact manner.

### BRIEF DESCRIPTION OF THE DRAWINGS

The present disclosure is explained in more detail below with reference to figures without limiting the general concept of the present disclosure.

In the drawings:

FIG. 1 shows a first embodiment of hybrid module having a torsional vibration damper and an axial flux machine in an axial sectional view;

FIG. 2 shows a second embodiment of hybrid module having a torsional vibration damper and a radial flux machine in an axial sectional view;

FIG. 3 shows magnet units of a rotor and a stator of an axial flux machine in a cut-out perspective view;

FIG. 4 shows a first embodiment of a rivet connection between a rotor hub and a rotor in an axial sectional view;

FIG. 5 shows a second embodiment of a rivet connection between a rotor hub and a rotor in an axial sectional view;

FIG. 6 shows a third embodiment of a rivet connection between a rotor hub and a rotor in an axial sectional view;

FIG. 7 shows a third embodiment of hybrid module having a torsional vibration damper and an axial flux machine in an axial sectional view;

FIG. 8 shows a fourth embodiment of hybrid module having a torsional vibration damper and an axial flux machine in an axial sectional view;

FIG. 9 shows a fifth embodiment of hybrid module having a torsional vibration damper and an axial flux machine in an axial sectional view;

FIG. 10 shows a sixth embodiment of hybrid module having a torsional vibration damper and an axial flux machine in an axial sectional view; and

FIG. 11 shows a motor vehicle with a hybrid drive train in a schematic block diagram.

### DETAILED DESCRIPTION

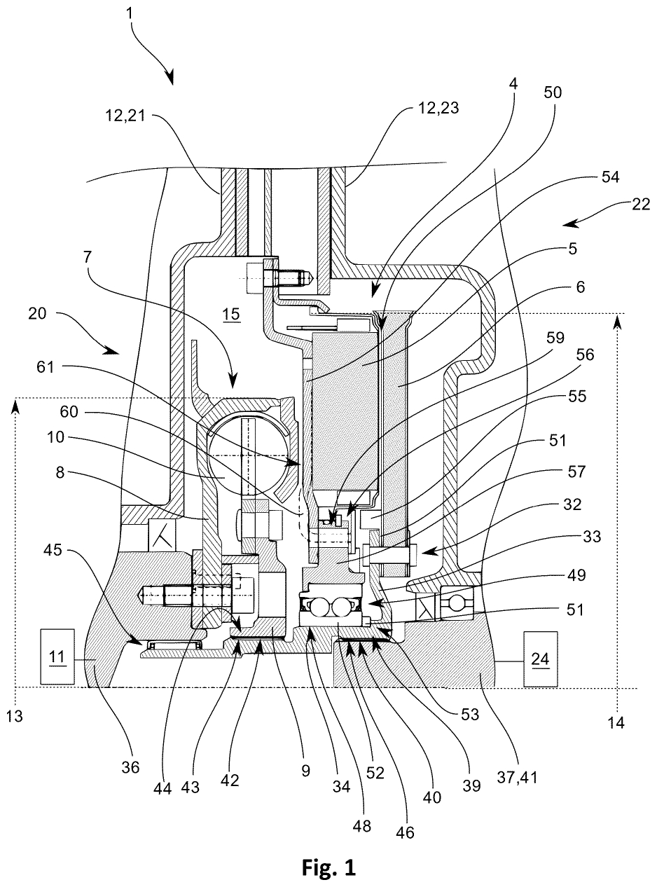

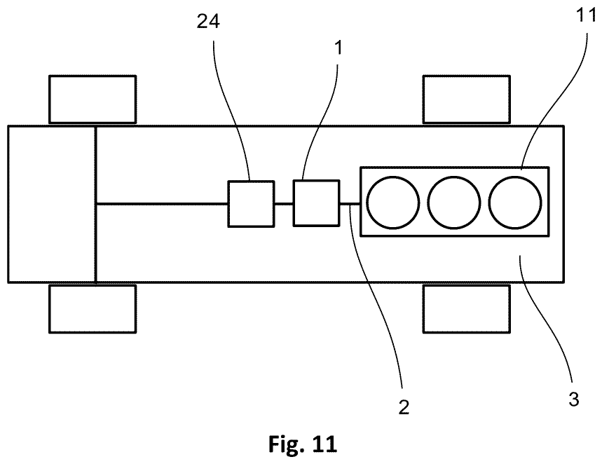

FIG. 1 shows a hybrid module 1 for a drive train 2 of a motor vehicle 3, as shown by way of example in FIG. 11. The hybrid module 1 includes an electric machine 4 having a stator 5 and a rotor 6 rotatable and mounted coaxially relative to the stator 5, and a vibration damper 7 arranged coaxially with respect to the rotor 6 and having a damper input part 8 and a damper output part 9, as well as at least one energy store 10 arranged in the torque flow between the damper input part 8 and the damper output part 9. The damper output part 9 is coupled to the rotor 6 and the damper input part 8 is coupled to the crankshaft 36 of an internal combustion engine 11 and is thus positioned axially between the internal combustion engine 11 and the electric machine 4 within the hybrid module 1. The electric machine 4 and the vibration damper 7 are accommodated in a hybrid module housing 12. The hybrid module 1 of FIG. 1 is thus configured as a P1 hybrid module in which the damper input part 8 is connected to the crankshaft 36 of the internal combustion engine 11, while the rotor 6 of the electric machine 4 is coupled to a transmission input shaft 37.

In the embodiment variant of FIG. 1, the electric machine 4 is designed as an axial flux machine.

The vibration damper 7 has an outer diameter 13 which is smaller than the stator diameter 14 of the stator 5, so that an installation space 15 is defined radially outside the vibration damper within the hybrid module housing 12, through which installation space at least one electrical connection means 16 of the electric machine 4 and/or at least one cooling connection means 17 of the electric machine 4 passes at least partially. The connection means 16, 17 may be designed, for example, as electrical lines or as hoses carrying a fluid. The installation space 15 may be designed as a wet chamber or a dry chamber.

Thus, the radial, annular installation space 15 above the torsional vibration damper 7 may be used for a corresponding electrical connection of the electric machine 4 and/or for the supply and removal of a cooling medium, for example cooling water or oil, as well as the installation of further elements such as cables/connections for low-voltage contacting of a rotor position sensor 56 and/or a temperature sensor, which favors a hybrid module 1 with a particularly compact axial design.

In order to prevent uncontrolled entry of moisture and/or contaminants into the P1 hybrid module 1, a seal (not further specified) is provided on both sides between the internal combustion engine 11 and the hybrid module 1 as well as between the hybrid module 1 and the transmission 24.

The hybrid module housing 12 is formed in several parts, which is formed at a first end face 20 at least partially by a housing 21 of the internal combustion engine 11 and at a second end face 22 at least partially by a housing 23 of a transmission 24.

The stator 5 is axially fixed to the hybrid module housing 12 via the stator carrier 54. The centering of the stator 5 on the hybrid module housing 12 is carried out via a hole or pin positioning and not via a radial seat, as is otherwise usual. The stator 5 or the stator carrier 54 has radial compliance, so that the stator 5 is radially decoupled from the hybrid module housing 12.

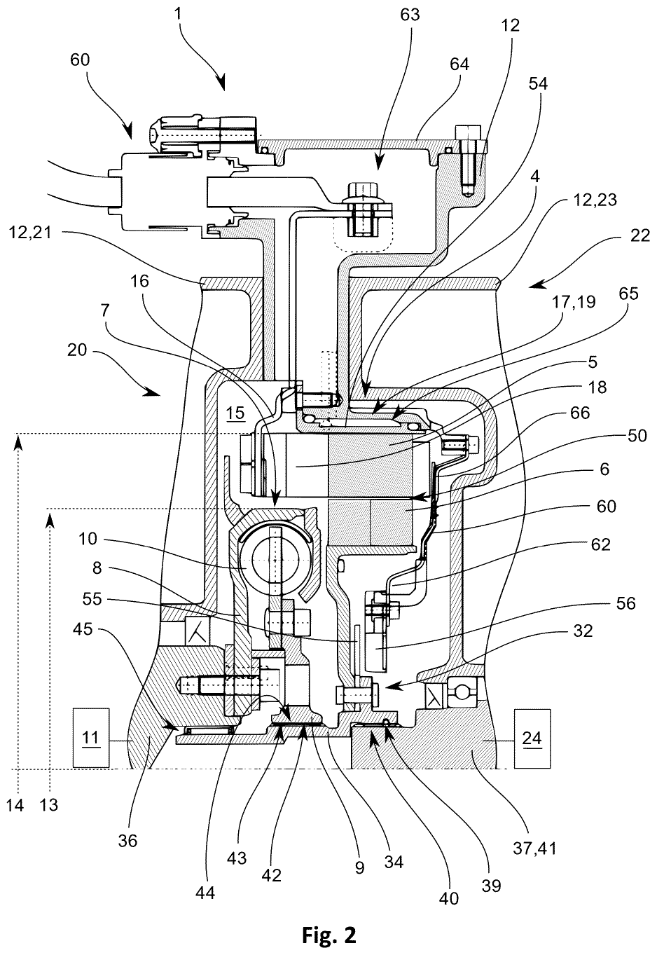

As may be clearly seen from FIG. 2, the electric machine 4 in this alternative embodiment is designed as a radial flux machine. In this case also, a hybrid module 1 may be seen, including an electric machine 4 having a stator 5 and a rotor 6 rotatable and mounted coaxially relative to the stator 5, and a vibration damper 7 arranged coaxially with respect to the rotor 6 and having a damper input part 8 and a damper output part 9, as well as at least one energy store 10 arranged in the torque flow between the damper input part 8 and the damper output part 9. The damper output part 9 is coupled to the rotor 6 and the damper input part 8 is coupled to the crankshaft 36 of an internal combustion engine 11 and is thus positioned axially between the internal combustion engine 11 and the electric machine 4 within the hybrid module 1. The electric machine 4 and the vibration damper 7 are accommodated in a hybrid module housing 12. The hybrid module 1 of FIG. 1 is thus configured as a P1 hybrid module in which the damper input part 8 is connected to the crankshaft 36 of the internal combustion engine 11, while the rotor 6 of the electric machine 4 is coupled to a transmission input shaft 37.

The vibration damper 7 has an outer diameter 13 which is smaller than the stator diameter 14 of the stator 5, so that an installation space 15 is defined radially outside the vibration damper and/or radially outside the stator 5 within the hybrid module housing 12, through which installation space at least one electrical connection means 16 of the electric machine 4 and/or at least one cooling connection means 17 of the electric machine 4 passes at least partially. The connection means 16, 17 may be designed, for example, as electrical lines or as hoses carrying a fluid. The installation space 15 may be designed as a wet chamber or a dry chamber.

FIG. 2 further shows that the vibration damper 7 and the stator 5 of the electric machine 4 are arranged radially nested in this embodiment.

The interface of the hybrid module 1 to the high-voltage terminal 58 of the motor vehicle 3 is located in the radially outer region of the hybrid module 1. Access to the connecting region 63, which in the exemplary embodiment shown includes a screw connection, is provided via an opening in the hybrid module housing 12, which is closed with a sealed cover 64 after the contact has been established and before commissioning.

The electric machine 4 shown may be connected to a cooling circuit 19, which may be coupled to the electric machine 4 via the at least one cooling connection means 17, so that the radial flux machine may be water-or oil-cooled. For this purpose, the electric machine 4 has a cylindrical annular, circumferential cooling channel 65 on its outer circumference, which channel is arranged radially between the stator carrier 54 and a portion of the hybrid module housing 12 of the hybrid module 1 and is sealed on both sides, e.g., via O-ring seals.

An unavoidable tilting of the rotor 6 or rotor hub 34 caused by tolerances and dynamic effects during operation is advantageously compensated for via the air gap 50 of the electric machine 4. The stator 5 is connected to the hybrid module housing 12 of the hybrid module 1 via the stator carrier 54 by means of a screw connection. This connection may be either rigid or vibration-decoupled.

The “marriage” of the radial flux machine is achieved by joining the stator 5 and rotor 6 during the assembly of the hybrid module 1 into the transmission 24. Thus, the electric machine 4, designed as a radial flux machine, only becomes a testable unit after it has been mounted on the transmission 24.

An inverter 18 for supplying current to the electric machine 4 is arranged in the installation space 15 and is connected to at least one electrical connection means 16. The radial, annular installation space above the torsional vibration damper 7 is used for the electrical connection and for the supply and removal of a cooling fluid.

The rotor hub 34 of the radial flux machine has interfaces to the torsional vibration damper 7, which in the embodiment shown is designed as a dual-mass flywheel, and to the transmission input shaft 37, which is formed in each case by a corresponding spline 40, 43. The rotor hub 34 also has a rolling bearing 45 (pilot bearing system) for the crankshaft 36 of the internal combustion engine 11. In contrast to the axial flux machine, as may be seen in FIG. 1, for example, this type of bearing system of rotor 6 or rotor hub 34 on the transmission and combustion engine side does not require a separate rolling bearing 49 and thus increases the efficiency of the overall system, since no additional bearing drag losses occur.

The axial securing of the rotor hub 34 is effected by means of a securing element on the transmission input shaft 37 or another suitable connection, such as a central screw connection.

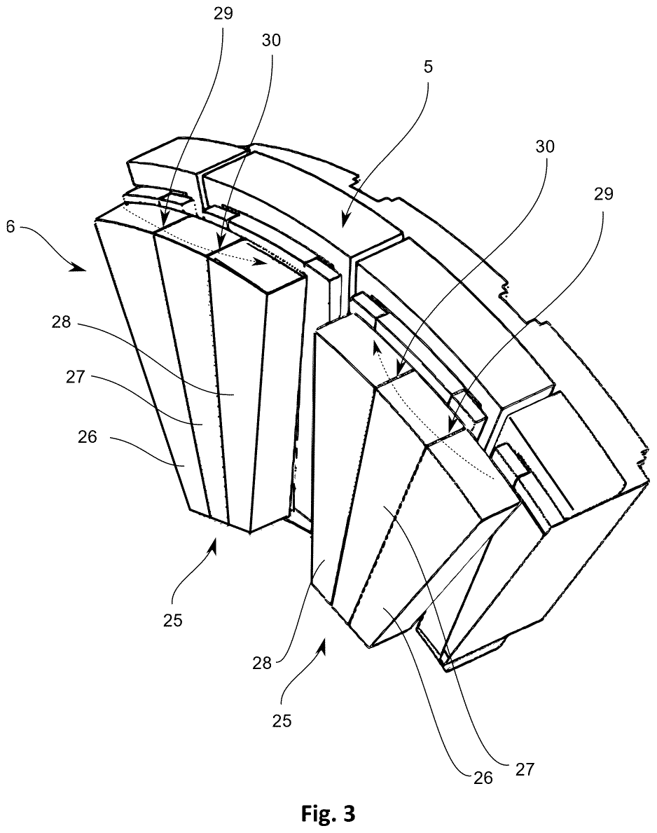

FIG. 3 shows a disc-like rotor 6 for an electric machine 4 configured as an axial flux machine, which rotor has a plurality of magnet units 25 arranged distributed in a circumferential direction over the rotor 6. Such a rotor 6 is installed, for example, in the embodiment shown in FIG. 1.

Each of the magnet units 25 has a first magnet element 26, a second magnet element 27 and a third magnet element 28, wherein the first magnet element 26 and the second magnet element 27 have a first contact surface 29 extending in a radial direction and the second magnet element 27 and the third magnet element 28 have a second contact surface 30 extending in a radial direction.

The magnet elements 26, 27, 28 are now magnetized in such a way that they form a Halbach array. The resulting magnetic flux through the magnet units 25 is indicated in FIG. 3 by the dashed arrows.

The magnet units 25 are designed to be substantially identical in each case and are arranged distributed equidistantly over the circumference of the rotor 6. The magnet units 25 in the rotor 6 may be surrounded by a fixing structure made of plastic. Due to the Halbach array of the magnet elements 26, 27, 28, it is possible that the electric machine 4 has exactly one stator 5 and one rotor 6 and may therefore be designed to be particularly compact axially while simultaneously having a high power density. This is also supported by the fact that the rotor 6 does not have a magnetic return path element, in particular no iron yoke.

In order to protect the magnet units 25 from mechanical influences and to fix them axially in the rotor, they are covered at least in portions on both sides by an annular disc-like cover disc 31 in an axial direction. The cover discs 31 may also be designed in a segment-like manner in a circumferential direction. The cover discs 31 are made of plastic or aluminum.

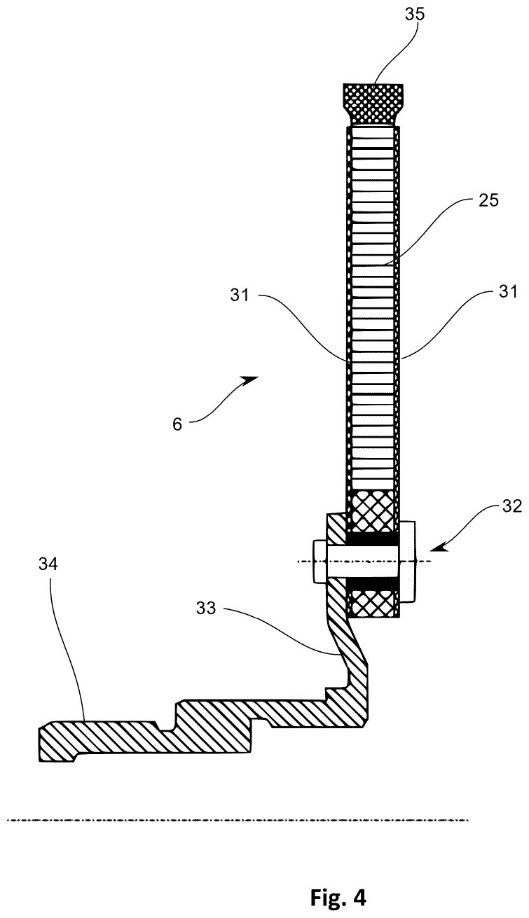

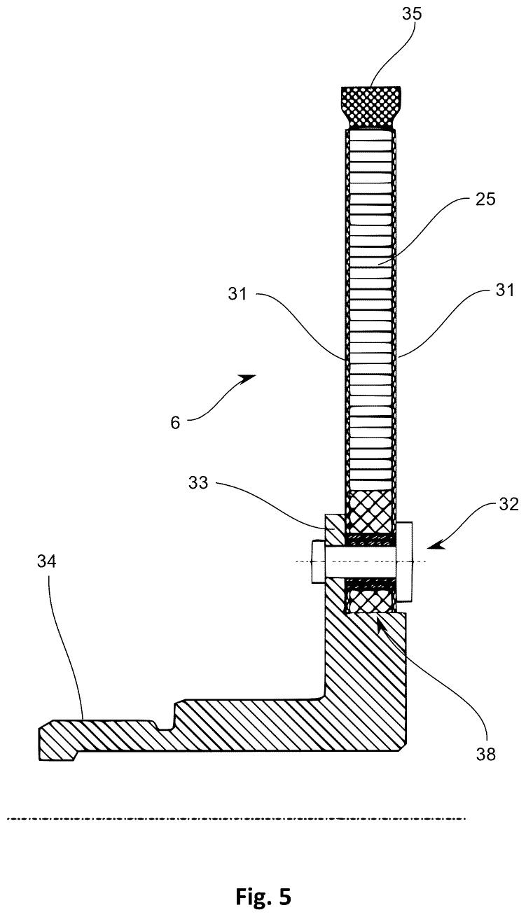

FIGS. 4-5 clearly show that the rotor 6 is fixed to a flange 33 of the rotor hub 34 in a torque-transmitting manner by means of rivet connections 32 extending in an axial direction. The rivet connections 32 each pass through the two cover discs 31 of the rotor 6. The magnet units 25 are secured radially in the rotor 6 by the annular bandage element 35.

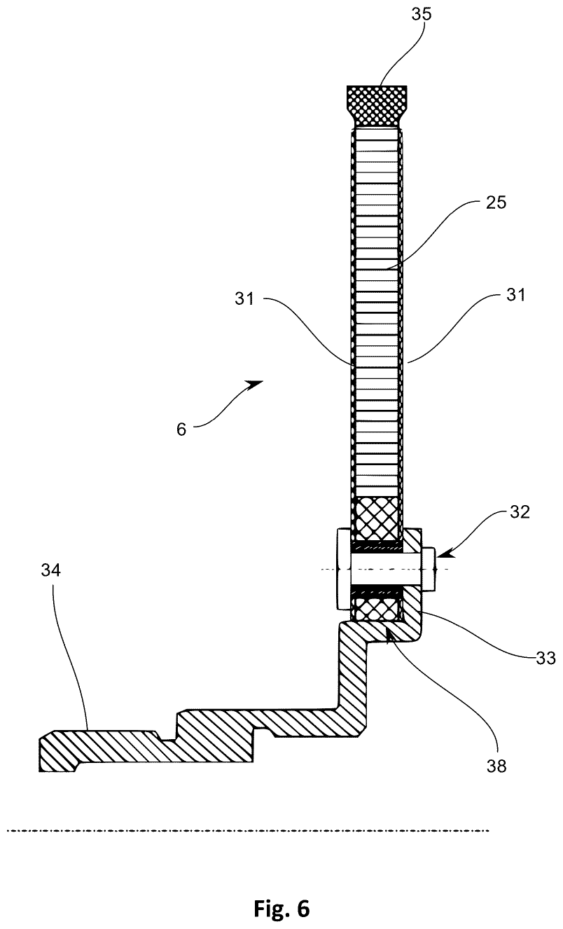

FIG. 4 shows an embodiment of a rotor hub 34 with a flange 33, in which the rotor 6 is also supported in a radial direction by the rivet connections 32. FIGS. 5-6, however, show designs in which the rotor 6 is supported in a radial direction on the flange 33 of the rotor hub 34 and accordingly bears against the annular sleeve portion 38 of the flange 33.

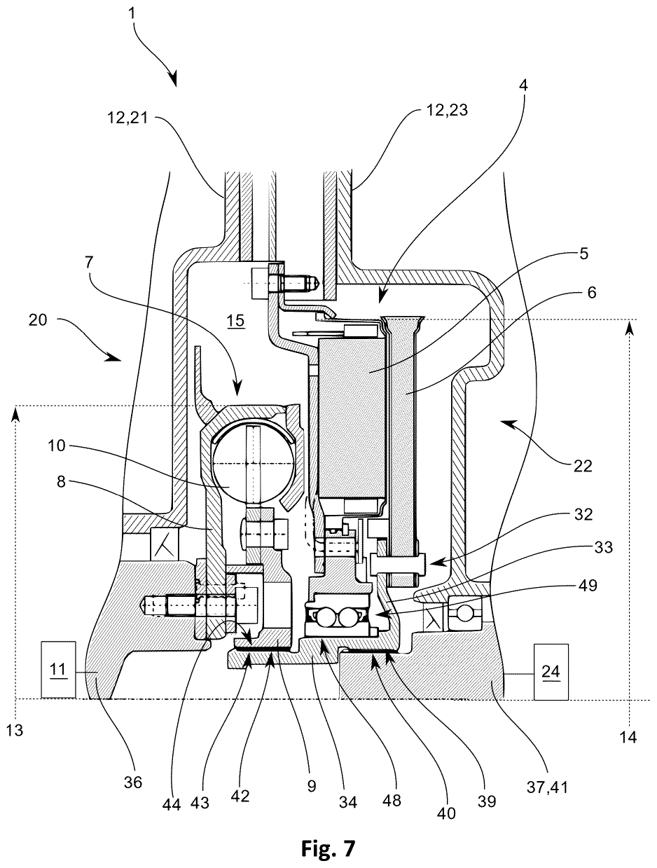

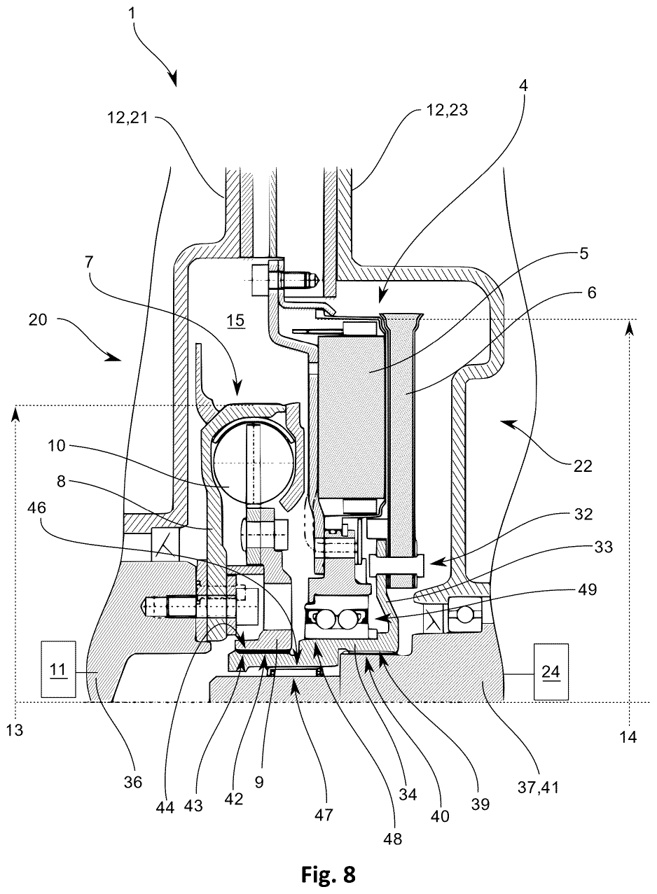

FIGS. 1, 7 and 8 show various connection and bearing system variants of the rotor hub and the rotor 6, which are explained in more detail below. FIG. 1, FIG. 7 and FIG. 8 each show a hybrid module 1 for a drive train 2 of a motor vehicle 3, including an electric machine 4 having a stator 5 and a rotor 6 rotatable and mounted coaxially relative to the stator 5, and a vibration damper 7 arranged coaxially with respect to the rotor 6 and having a damper input part 8 and a damper output part 9, as well as at least one energy store 10 arranged in the torque flow between the damper input part 8 and the damper output part 9. The damper output part 9 is coupled to the rotor 6 and the damper input part 8 to an internal combustion engine 11. The electric machine 4 and the vibration damper 7 are accommodated in a hybrid module housing 12.

The rotor 6 is connected to the rotor hub 34 in a torque-transmitting manner, the rotor hub 34 including a first connection portion 39 having an internal spline 40 for torque-transmitting coupling to a shaft 41 and a second connection portion 42 having an external spline 43, the external spline 43 engaging with a corresponding internal spline 44 of the damper output part 9. The rotor 6 or the rotor hub 34 thus has two axially spaced interfaces, one to the torsional vibration damper 7 and one to the transmission 24, each by means of a spline. This may be seen particularly well in the representation in FIG. 7. The external spline 43 has a diameter that is smaller than the diameter of the outer lateral surface of the rotor hub 34, which facilitates axial insertion of the rotor hub 34 during assembly.

Furthermore, the internal spline 44 has a diameter that is larger than the diameter of the inner lateral surface 46 of the rotor hub 34. Axially between the external spline 43 and the internal spline 44 of the rotor hub 34, a third rolling bearing 49 is arranged on the outer lateral surface 48 of the rotor hub, which bearing rotatably supports the rotor hub 34 relative to the stator 5. The third rolling bearing 49 is configured as a double-row deep groove ball bearing with an O arrangement, which increases the support base of the bearing.

The rotor 6 of the axial flux machine generates an axial force on the stator 5, which is absorbed by the rolling bearing 49. The axial flux machine is thus internally sealed with respect to force. No axial forces act from the axial flux machine on the transmission 24. The internal power flow occurs via the third rolling bearing 49, which is arranged radially inside the stator 5. The rolling bearing 49 is connected to the stator 5 in a radial direction by means of an annular stator carrier 54 connecting the rolling bearing 49 and the stator 5. The axial flux machine thus forms a separate, testable unit and all necessary measurements may be carried out before final installation in the drive train 2.

The configuration of the axial flux machine with exactly one stator (5) and one rotor (6) results in a one-sided rotor loading. To prevent the rotor 6 from folding against the stator 5 during assembly due to the magnetic attraction forces, a wide bearing base may be used, in which so-called pilot bearings are used, which is described below. For stabilization purposes, the rotor hub 34 may be extended axially in the direction of the torsional vibration damper 7, thereby forming an additional bearing seat for a rolling bearing 45 (pilot bearing) to the crankshaft 36. This embodiment variant is shown in FIG. 1. It may be clearly seen that the first rolling bearing 45 (pilot bearing) is arranged at the end of the rotor hub 34 pointing in the direction of the internal combustion engine 11, and, when the hybrid module 1 is installed with the internal combustion engine 11, the rotor hub 34 engages axially in a crankshaft 36 and may be rotatably mounted relative to the crankshaft 36 via the first rolling bearing 45.

An alternative solution is to extend the transmission input shaft 37 axially and to realize a bearing seat with a rolling bearing 47 (pilot bearing) between the rotor hub 34 and the transmission input shaft 37, as shown in FIG. 8. The second rolling bearing 47 (pilot bearing) is arranged axially between the external spline 43 and the internal spline 44 of the rotor hub 34 on its inner lateral surface 46, which bearing rotatably supports the rotor hub 34 relative to the shaft 41 or transmission input shaft 37.

The first rolling bearing 45 and the second rolling bearing 47 are designed as needle bearings in the embodiments shown.

The adjustment of the air gap 50 between the stator 5 and the rotor 6 may be carried out by means of one or more shim washers 51 and is explained in more detail below with reference to FIG. 1. In FIG. 1, the electric machine 4 is designed as an axial flux machine, the disc-like rotor 6 of which is connected to the rotor hub 34 in a torque-transmitting manner, which has a rolling bearing 49 on its outer lateral surface 48, which rolling bearing rotatably supports the rotor hub 34 relative to the stator 5, and the air gap 50 between the stator 5 and the rotor 6 is adjusted by means of a shim washer 51 arranged on the rotor hub 34.

For this purpose, the shim washer 51 may axially bear, on the one hand, against the inner ring 52 of the rolling bearing 49 and, on the other hand, against a shoulder 53 of the rotor hub 34. It is also possible for the shim washer 51 to bear axially against a flange 33 of the rotor hub 34 on one hand and on the rotor 6 on the other hand. Both alternatives are shown in FIG. 1. It is understood that only one shim washer 51 may be present.

The air gap 50 between the stator 5 and the rotor 6 is thus adjusted within the electric machine 4. For this purpose, both the axial stator height and the rotor height may be measured during the construction of the electric machine 4. A suitable shim washer 51 is then selected and installed between the rolling bearing 49 and the rotor hub 34. The axial air gap 50 is thus defined and fixed.

An alternative to axially shimming the rotor 6 is to integrate a shim washer 51 between the rotor hub 34 and the rotor 6, which has already been described above.

FIGS. 1-2 and FIGS. 7-9 further show that the rotor 6 is torque-transmittingly fixed to a flange 33 of a rotor hub 34 by means of rivet connections 32 extending in an axial direction. This means that the usual screw connections are replaced by a plurality of rivet connections 32. In this case, the torque is transmitted via shear at the interface of the rivet connection 32 to the flange 33, wherein the two rivet heads of a rivet only serve to axially secure the rivet connection 32.

As may be seen in FIGS. 1-2 and FIGS. 9-10, the hybrid module 1 may have a rotor position sensor 56. As already explained elsewhere, the rotor 6 is torque-transmittingly connected to a rotor hub 34, and a sensor target 55 of a rotor position sensor 56 is coupled to the rotor hub 34 in a rotationally fixed manner. The sensor target 55 extends in a radial direction out of the rotor hub 34 and is designed as a toothed ring. The sensor target 55 and the rotor position sensor 56 are arranged in a space radially inside the stator 5.

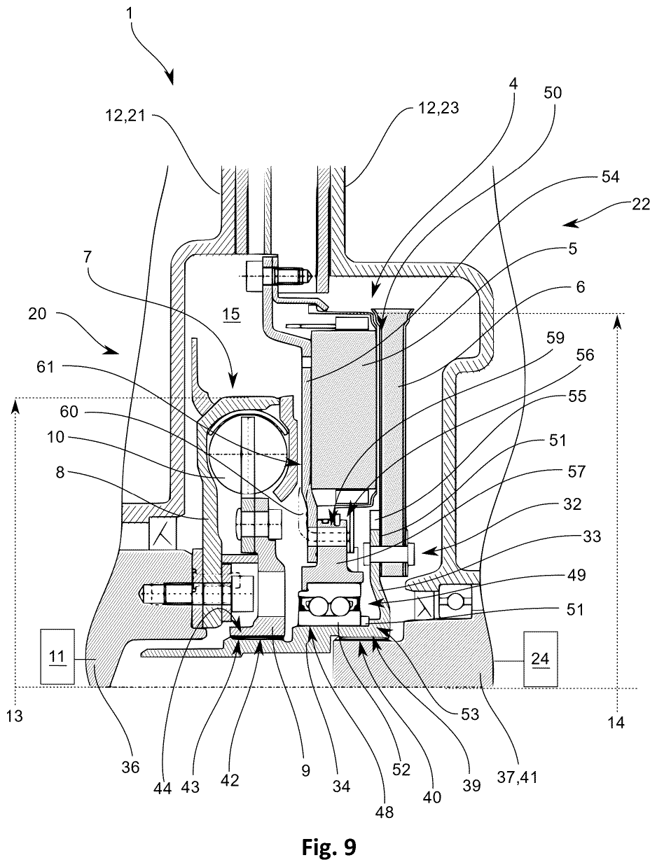

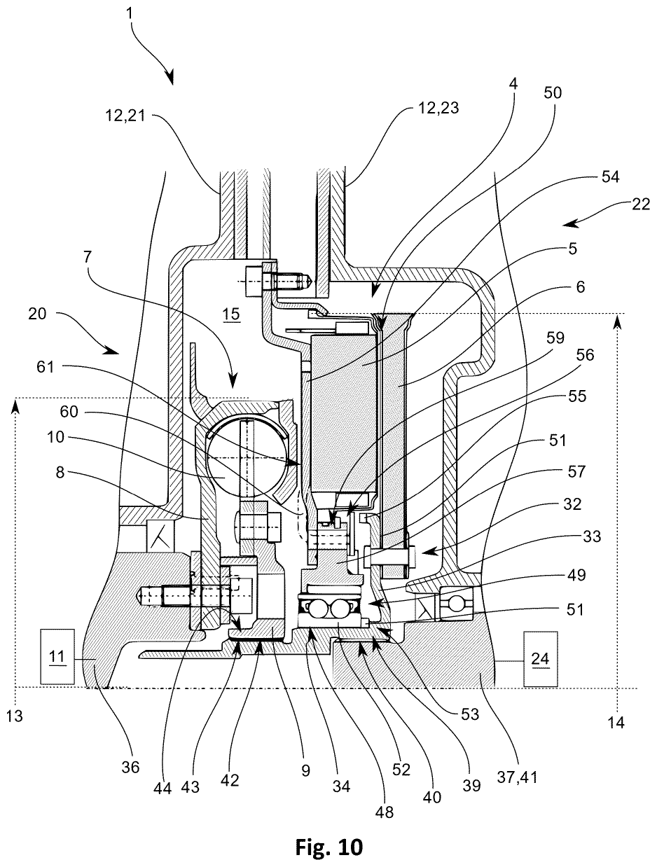

While the sensor target 55 in the embodiment of FIG. 1 and FIG. 2 is arranged as a separate component on the flange 33 of the rotor hub 34 by means of a rivet connection 32, the sensor target 55 in FIGS. 9-10 is formed integrally, in particular monolithically, with the rotor hub 34.

In FIG. 1 and in FIGS. 9-10, the rotor position sensor 56 is arranged on a rotationally fixed stator hub 57, which connects the rotatable rotor hub 34 to a stator carrier 54 of the stator 5 with the interposition of a rolling bearing 49. The stator hub 57 has a cable channel 59 which runs axially through the stator hub 57 and through which at least one electrical line 60 passes for electrical contact with the rotor position sensor 56. The stator carrier 54 further has at least one cable slot 61 extending in a radial direction, in which slot the electrical line 60 is guided at least in partially for electrical contact with the rotor position sensor 56.

In FIG. 2, the electric machine 4 is configured as a radial flux machine, in which a carrier component 62, arranged in a rotationally fixed manner with the stator 5 and extending inward in a radial direction, carries the rotor position sensor 56. This carrier component 62 is connected to the hybrid module housing 12 of the hybrid module 1 in a radially outer region by means of a screw connection. The carrier component 62 is designed such that the cables of the rotor position sensor 56 may be laid and secured from the radially inner region to the radially outer region in the most space-saving manner possible. An additional shielding element 66, e.g., a plastic part, is arranged axially between the right winding head of the radial flux machine and the region of the carrier component 62, which guides the cables of the rotor position sensor 56 to the outside.

The present disclosure is not limited to the embodiments shown in the figures. The above description is therefore not to be regarded as limiting, but rather as illustrative. The following claims are to be understood as meaning that a stated feature is present in at least one embodiment of the present disclosure. This does not exclude the presence of further features. Where the claims and the above description define ‘first’ and ‘second’ features, this designation serves to distinguish between two features of the same type without defining an order of precedence.

### LIST OF REFERENCE SIGNS

1 Hybrid module
2 Drive train
3 Motor vehicle
4 Electric machine
5 Stator
6 Rotor
7 Vibration damper
8 Damper input part
9 Damper output part
10 Energy store
11 Internal combustion engine
12 Hybrid module housing
13 Diameter
14 Stator diameter
15 Installation space
16 Connection means
17 Connection means
18 Inverter
19 Cooling circuit
20 End face
21 Housing
22 End face
23 Housing
24 Transmission
25 Magnet units
26 Magnet element
27 Magnet element
28 Magnet element
29 Contact surface
30 Contact surface
31 Cover disc
32 Rivet connection
33 Flange
34 Rotor hub
35 Bandage element
36 Crankshaft
37 Transmission input shaft
38 Sleeve portion
39 Connection portion
40 Internal spline
41 Shaft
42 Connection portion
43 External spline
44 Internal spline
45 Rolling bearing
46 Lateral surface
47 Rolling bearing
48 Lateral surface
49 Rolling bearing
50 Air gap
51 Shim washer
52 Inner ring
53 Shoulder
54 Stator carrier
55 Sensor target
56 Rotor position sensor
57 Stator hub
58 High-voltage terminal
59 Cable channel
60 Line
61 Cable slot
62 Carrier component
63 Connecting region
64 Cover
65 Cooling channel
66 Shielding element

1. A hybrid module for a drive train of a motor vehicle comprising:
an electric machine having a stator and a rotor rotatable and mounted coaxially relative to the stator,
a hybrid module housing,
a rotor hub.
a rotor position sensor having a sensor target, and
a vibration damper arranged coaxially with respect to the rotor and having a damper input part, and a damper output part, and at least one energy store arranged in a torque flow between the damper input part and the damper output part the damper output part being coupled to the rotor and the damper input part being couplable to an internal combustion engine, the electric machine and the vibration damper being accommodated in the hybrid module housing,
wherein the rotor is torque-transmittingly connected to the rotor hub and the sensor target of the rotor position sensor is coupled to the rotor hub in a rotationally fixed manner.

2. The hybrid module according to claim 1, wherein the sensor target extends in a radial direction out of the rotor hub.

3. The hybrid module according to claim 1, wherein the sensor target is configured as a component separate from the rotor hub.

4. The hybrid module according to claim 1, wherein the sensor target is formed integrally with the rotor hub.

5. The hybrid module according to claim 1, wherein the sensor target is configured as a toothed ring.

6. The hybrid module according to claims 1, wherein at least one of the sensor target and/or the rotor position sensor arranged in a space radially within the stator.

7. The hybrid module according to claim 1, wherein the stator comprises an annular stator carrier, wherein the stator is mounted in an axial direction relative to the hybrid module housing by the annular stator carrier, and the stator has no radial contact with the hybrid module housing.

8. The hybrid module according to claim 1, further comprising a roller bearing and a stator hub that is rotationally fixed, wherein the stator comprises a stator carrier and the rotor position sensor is arranged on a the fixed stator hub which, via interposition of the rolling bearing, connects the rotatable rotor hub to the stator carrier of the stator.

9. The hybrid module according to claim 1, further comprising at least one electrical line, wherein the stator hub has a cable channel which runs axially through the stator hub and through which the at least one electrical line passes for electrical contact with the rotor position sensor.

10. The hybrid module according to claim 1, further comprising an electrical line, wherein the stator comprises a stator carrier, the stator carrier has at least one cable guide extending in a radial direction, in which the electrical line is guided at least partially for electrical contact with the rotor position sensor.

11. The hybrid module according to claim 1, further comprising a carrier component, wherein the electric machine is configured as a radial flux machine, wherein the carrier component is arranged in a rotationally fixed manner with the stator and extending inwardly in a radial direction, and carries the rotor position sensor.

12. The hybrid module according to claim 4, wherein the sensor target is formed monolithically with the rotor hub.

13. The hybrid module according to claim 10, wherein the at least one cable guide comprises at least one cable slot.
